(19) United States
(12) Patent Application Publication
(10) Pub. No.: US 2026/0129680 A1
(43) Pub. Date: May 7, 2026

(54) EFFICIENT TRANSMISSION FOR IN-DEVICE-COEXISTENCE

(71) Applicant: Senscomm Semiconductor Co., Ltd., Suzhou (CN)

(72) Inventors: Sung Jin PARK, Seoul (KR); Daehong KIM, Laguna Hills, CA (US)

(21) Appl. No.: 19/340,694

(22) Filed: Sep. 25, 2025

Related U.S. Application Data
(60) Provisional application No. 63/715,460, filed on Nov. 1, 2024.

(51) Int. Cl. H04W 74/0816; H04L 1/00; H04W 8/22

(52) U.S. Cl. CPC H04W 74/0816; H04L 1/0003; H04W 8/22

(57) ABSTRACT

An access point (AP) device for facilitating communication in a wireless network. The AP device has a memory and a processor coupled to the memory. The AP device transmits, to a station (STA) device, a request frame requesting information associated with an unavailability period, wherein the STA device is not available for transmitting or receiving frames during the unavailability period. The AP device receives, from the STA device, a response frame including information associated with the unavailability period. The AP device transmits, to the STA device, a first data frame based on the information associated with the unavailability period, wherein transmission of the first data frame is completed before a start of the unavailability period.

### CROSS REFERENCE TO RELATED APPLICATION

This application claims benefit of U.S. Provisional Application No. 63/715,460, entitled “EFFICIENT TRANSMISSION FOR IN-DEVICE-COEXISTENCE,” filed on Nov. 1, 2024, the entire contents of which are hereby incorporated by reference.

### TECHNICAL FIELD

This disclosure relates generally to a wireless communication system, and more particularly to, for example, but not limited to, efficient transmission in wireless networks.

### BACKGROUND

Wireless local area network (WLAN) devices are widely deployed in diverse environments to provide various communication services such as video, cloud access, broadcasting and offloading. Some of these environments have a lot of access point (AP) stations and non-AP stations in geographically limited areas. The WLAN technology has evolved toward increasing data rates and continues its growth in various markets such as home, enterprise and hotspots over the years since the late 1990s. Recently released standard (IEEE 802.11ax-2021) provides improved network performance in the high-density scenario by adopting OFDMA and MU-MIMO technologies. These improvements can be used to support environments such as outdoor hotspots, dense residential/office area, and stadiums.

The Wi-Fi system has a transmission opportunity (TXOP) sharing framework. The TXOP sharing may allow an access point (AP) station (STA) to allocate time within an obtained TXOP to an associated non-AP STA. The non-AP STA to which time is allocated by the AP may transmit uplink (UL) data without receiving a trigger frame from the AP and may communicate peer-to-peer with other non-AP STAs within the same basic service set (BSS).

However, since the existing TXOP sharing enables the AP to allocate time resources to only one STA, it can limit traffic throughput. Moreover, it is inefficient in terms of channel utilization as it only allocates time without considering the available frequency resources.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide an efficient transmission to minimize the impact of in-device coexistence (IDC) interference.

An aspect of the disclosure provides an access point (AP) device for facilitating communication in a wireless network. The AP comprises a memory and a processor coupled to the memory. The processor is configured to cause transmitting, to a station (STA) device, a request frame requesting information associated with an unavailability period, wherein the STA device is not available for transmitting or receiving frames during the unavailability period. The processor is further configured to cause receiving, from the STA device, a response frame including information associated with the unavailability period. The processor is further configured to cause transmitting, to the STA device, a first data frame based on the information associated with the unavailability period, wherein transmission of the first data frame is completed before a start of the unavailability period.

In an embodiment, the processor is further configured to cause transmitting, to the STA device, a second data frame after the unavailability period, wherein the first data frame includes a portion of data that the AP device intends to transmit, and the second data frame includes a remaining portion of the data.

In an embodiment, the request frame includes a request that the STA device increases the STA device's reception capability. The response frame includes an indication of the STA device's increased reception capability. The first data frame is transmitted based on the STA device's increased reception capability.

In an embodiment, the first data frame is transmitted based on a modulation and coding scheme associated with the STA device's increased reception capability or a number of spatial streams associated with the STA device's increased reception capability.

In an embodiment, the request frame includes a request for information on an alternative channel which is available during the unavailability period. The response frame includes information on an alternative channel which is available during the unavailability period. The processor is further configured to cause transmitting, to the STA device, a second data frame on the alternative channel during the unavailability period, wherein the first data frame includes a portion of data that the AP device intends to transmit, and the second data frame includes a remaining portion of the data.

In an embodiment, the first data frame is transmitted on a primary channel, and the alternative channel is a secondary channel.

In an embodiment, the response frame includes information on a plurality of alternative channels which are available during the unavailability period. The processor is further configured to cause selecting the alternative channel from the plurality of alternative channels.

In an embodiment, the alternative channel is determined to be available if signal strength of interference on the alternative channel is below a predetermined threshold during the unavailability period.

In an embodiment, the AP device is an AP multi-link device (MLD) comprising a plurality of APs. The STA device is an STA MLD comprising a plurality of STAs. The first data frame is transmitted on a first link established between the AP device and the STA device. The processor is further configured to cause transmitting, to the STA device, a second data frame on a second link established between the AP device and the STA device during the unavailability period, wherein the second link is available during the unavailability period, and the first data frame includes a portion of data that the AP device intends to transmit, and the second data frame includes a remaining portion of the data.

In an embodiment, the information associated with the unavailability period comprises a start time, a duration, a frequency band, an identifier of links affected by the unavailability period, or an indication that the unavailability period is associated with device coexistence interference.

An aspect of the disclosure provides an STA device for facilitating communication in a wireless network. The STA comprises a memory and a processor coupled to the memory. The processor is configured to cause receiving, from an AP device, a request frame requesting information associated with an unavailability period, wherein the STA device is not available for transmitting or receiving frames during the unavailability period. The processor is further configured to cause transmitting, to the AP device, a response frame including information associated with the unavailability period. The processor is further configured to cause receiving, from the AP device, a first data frame, wherein transmission of the first data frame is completed before a start of the unavailability period.

In an embodiment, the processor is further configured to cause receiving, from the AP device, a second data frame after the unavailability period, wherein the first data frame includes a portion of data that the AP device intends to transmit, and the second data frame includes a remaining portion of the data.

In an embodiment, the request frame includes a request that the STA device increases the STA device's reception capability. The response frame includes an indication of the STA device's increased reception capability. The first data frame is transmitted based on the STA device's increased reception capability.

In an embodiment, the first data frame is transmitted based on a modulation and coding scheme associated with the STA device's increased reception capability or a number of spatial streams associated with the STA device's increased reception capability.

In an embodiment, the request frame includes a request for information on an alternative channel which is available during the unavailability period. The response frame includes information on an alternative channel which is available during the unavailability period. The processor is further configured to cause receiving, from the AP device, a second data frame on the alternative channel during the unavailability period, wherein the first data frame includes a portion of data that the AP device intends to transmit and the second data frame includes a remaining portion of the data.

In an embodiment, the first data frame is transmitted on a primary channel, and the alternative channel is a secondary channel.

In an embodiment, the alternative channel is determined to be available if signal strength of interference on the alternative channel is below a predetermined threshold during the unavailability period.

In an embodiment, the STA device is an STA MLD comprising a plurality of STAs.

The AP device is an AP MLD comprising a plurality of APs. The first data frame is transmitted on a first link established between the AP device and the STA device. The processor is further configured to cause receiving, from the AP device, a second data frame on a second link established between the AP device and the STA device during the unavailability period, wherein the second link is available during the unavailability period, and the first data frame includes a portion of data that the AP device intends to transmit, and the second data frame includes a remaining portion of the data.

In an embodiment, the information associated with the unavailability period comprises a start time, a duration, a frequency band, an identifier of links affected by the unavailability period, or an indication that the unavailability period is a result of device coexistence interference.

An aspect of the disclosure provides a method performed by an AP device for facilitating communication in a wireless network. The method comprises transmitting, to an STA device, a request frame requesting information associated with an unavailability period, wherein the STA device is not available for transmitting or receiving frames during the unavailability period. The method further comprises receiving, from the STA device, a response frame including information associated with the unavailability period. The method further comprises transmitting, to the STA device, a first data frame based on the information associated with the unavailability period, wherein transmission of the first data frame is completed before a start of the unavailability period.

### BRIEF DESCRIPTION OF THE DRAWINGS

FIG. 1 shows a schematic diagram of an example wireless communication network.

FIG. 2 shows an example of a timing diagram of interframe space (IFS) relationships between wireless devices in accordance with an embodiment.

FIG. 3 shows an OFDM symbol and an OFDMA symbol in accordance with an embodiment.

FIG. 4A shows the EHT MU PPDU format in accordance with an embodiment.

FIG. 4B shows the EHT TB PPDU format in accordance with an embodiment.

FIG. 5 shows a block diagram of an electronic device for facilitating wireless communication in accordance with an embodiment.

FIG. 6 shows a schematic diagram of an example of a transceiver in accordance with an embodiment.

FIG. 7 shows a schematic diagram of an example of a receiver in accordance with an embodiment.

FIG. 8 shows an example multiple link operation in accordance with an embodiment.

FIG. 9 shows an example PPDU transmission in accordance with an embodiment.

FIG. 10 shows another example PPDU transmission in accordance with an embodiment.

FIG. 11 shows example PPDU transmissions in accordance with an embodiment.

FIG. 12 shows further example PPDU transmissions in accordance with an embodiment.

FIG. 13 shows an example process in accordance with an embodiment.

FIG. 14 shows another example process in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The detailed description set forth below is intended to describe various implementations and is not intended to represent the only implementation. As those skilled in the art would realize, the described implementations may be modified in various different ways, all without departing from the scope of the present disclosure. Accordingly, the drawings and description are to be regarded as illustrative in nature and not restrictive. Like reference numerals designate like elements.

The below detailed description herein has been described with reference to a wireless LAN system according to the Institute of Electrical and Electronics Engineers (IEEE) 802.11 wireless standards including the current and future amendments. However, a person having ordinary skill in the art will readily recognize that the teachings herein are applicable to other network environments, such as cellular telecommunication networks and wired telecommunication networks.

In an embodiment, apparatus or devices such as an AP STA and a non-AP may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. The apparatus may also include one or more other hardware or software elements such as a network interface and a display device.

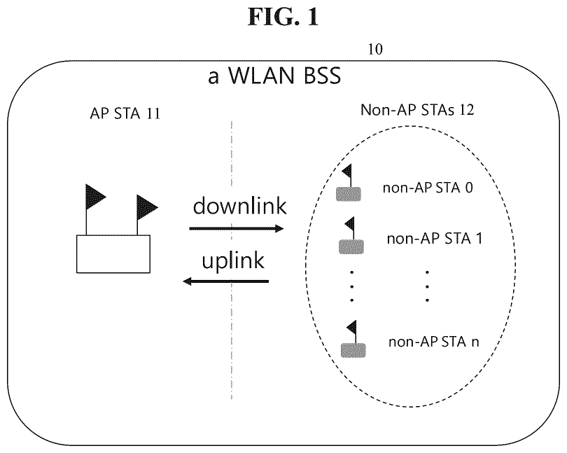

FIG. 1 shows a schematic diagram of an example wireless communication network.

Referring to FIG. 1, a basic service set (BSS) 10 may include a plurality of stations (STAs) including an access point (AP) station (AP STA) 11 and one or more non-AP station (non-AP STA) 12. For convenience, the non-AP STA may be referred to interchangeably as a user or an STA. The STAs may share a same radio frequency channel with one out of WLAN operation bandwidth options (e.g., 20/40/80/160/320 MHz). Hereinafter, in an embodiment, the AP STA and the non-AP STA may be referred as AP and STA, respectively. In an embodiment, the AP STA and the non-AP STA may be collectively referred as station (STA).

The plurality of STAs may participate in multi-user (MU) transmission. In the MU transmission, the AP STA 11 may simultaneously transmit the downlink (DL) frames to the multiple non-AP STAs 12 in the BSS 10 based on different resources and the multiple non-AP STAs 12 may simultaneously transmit the uplink (UL) frames to the AP STA 11 in the BSS 10 based on different resources.

For the MU transmission, multi-user multiple input, multiple output (MU-MIMO) transmission or orthogonal frequency division multiple access (OFDMA) transmission may be used. In MU-MIMO transmission, with one or more antennas, the multiple non-AP STAs 12 may either simultaneously transmit to the AP STA 11 or simultaneously receive from the AP STA 11 independent data streams over the same subcarriers. Different frequency resources may be used as the different resources in the MU-MIMO transmission. In OFDMA transmission, the multiple non-AP STAs 12 may either simultaneously transmit to the AP STA 11 or simultaneously receive from the AP STA 11 independent data streams over different groups of subcarriers. Different spatial streams may be used as the different resources in MU-MIMO transmission.

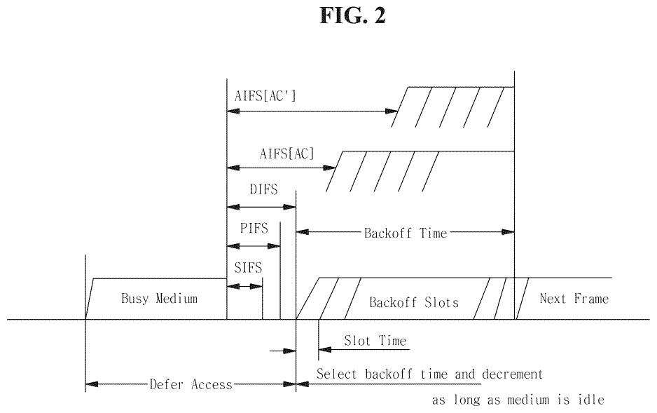

FIG. 2 shows an example of a timing diagram of interframe space (IFS) relationships between stations in accordance with an embodiment.

In particular, FIG. 2 shows a CSMA (carrier sense multiple access)/CA (collision avoidance) based frame transmission procedure for avoiding collision between frames in a channel.

A data frame, a control frame, or a management frame may be exchanged between STAs.

The data frame may be used for transmission of data forwarded to a higher layer. Referring to FIG. 2, access is deferred while the medium is busy until a type of IFS duration has elapsed. The STA may transmit the data frame after performing backoff if a distributed coordination function IFS (DIFS) has elapsed from a time when the medium has been idle.

The management frame may be used for exchanging management information which is not forwarded to the higher layer. Subtype frames of the management frame may include a beacon frame, an association request/response frame, a probe request/response frame, and an authentication request/response frame.

The control frame may be used for controlling access to the medium. Subtype frames of the control frame include a request to send (RTS) frame, a clear to send (CTS) frame, and an acknowledgement (ACK) frame. In the case that the control frame is not a response frame of the other frame, the STA may transmit the control frame after performing backoff if the DIFS has elapsed. If the control frame is the response frame of a previous frame, the WLAN device may transmit the control frame without performing backoff when a short IFS (SIFS) has elapsed. The type and subtype of frame may be identified by a type field and a subtype field in a frame control field.

On the other hand, a Quality of Service (QoS) STA may transmit the frame after performing backoff if an arbitration IFS (AIFS) for access category (AC), i.e., AIFS [AC] has elapsed. In this case, the data frame, the management frame, or the control frame which is not the response frame may use the AIFC [AC].

In an embodiment, a point coordination function (PCF) enabled AP STA may transmit the frame after performing backoff if a PCF IFS (PIFS) has elapsed. The PIFS duration may be less than the DIFS but greater than the SIFS.

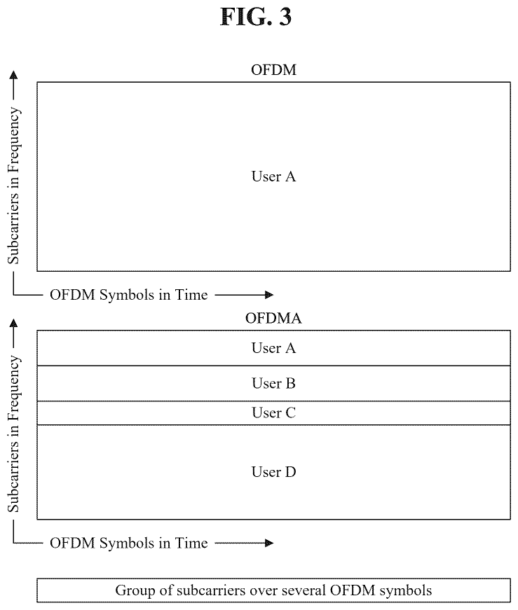

FIG. 3 shows an OFDM symbol and an OFDMA symbol in accordance with an embodiment.

For multi-user access modulation, the orthogonal frequency division multiple access (OFDMA) for uplink and downlink has been introduced in IEEE 802.11ax standard known as High Efficiency (HE) WLAN and will be used in 802.11's future amendments such as EHT (Extreme High Throughput). One or more STAs may be allowed to use one or more resource units (RUs) throughout operation bandwidth to transmit data at the same time. As the minimum granularity, one RU may comprise a group of predefined number of subcarriers and be located at predefined location in orthogonal frequency division multiplexing (OFDM) modulation symbol. Here, non-AP STAs may be associated or non-associated with AP STA when responding simultaneously in the assigned RUs within a specific period such as an SIFS. The SIFS may refer to the time duration from the end of the last symbol, or signal extension if present, of the previous frame to the beginning of the first symbol of the preamble of the subsequent frame.

The OFDMA is an OFDM-based multiple access scheme where different subsets of subcarriers may be allocated to different users, allowing simultaneous data transmission to or from one or more users with high accuracy synchronization for frequency orthogonality. In OFDMA, users may be allocated different subsets of subcarriers which can change from one physical layer (PHY) protocol data unit (PPDU) to the next. In OFDMA, an OFDM symbol is constructed of subcarriers, the number of which is a function of the PPDU bandwidth. The difference between OFDM and OFDMA is illustrated in FIG. 3.

In a case of UL MU transmission, given different STAs with their own capabilities and features, the AP STA may want to have more control mechanism of the medium by using more scheduled access, which may allow more frequent use of OFDMA/MU-MIMO transmissions. PPDUs in UL MU transmission (MU-MIMO or OFDMA) may be sent as a response to the trigger frame sent by the AP. The trigger frame may have STA's information and assign RUs and multiple RUS (MRUs) to STAs. The STA's information in the trigger frame may comprise STA Identification (ID), MCS (modulation and coding scheme), and frame length. The trigger frame may allow an STA to transmit trigger-based (TB) PPDU (e.g., HE TB PPDU or EHT TB PPDU) which is segmented into an RU and all RUs as a response of Trigger frame are allocated to the solicited non-AP STAs accordingly. Hereafter, a single RU and a multiple RU may be referred to as the RU. The multiple RU may include predefined two, three, or more RUs.

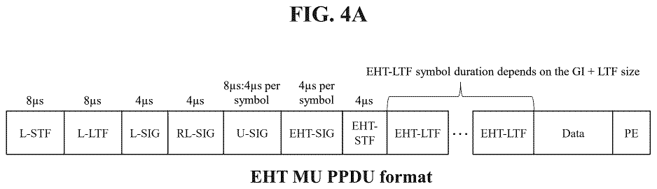

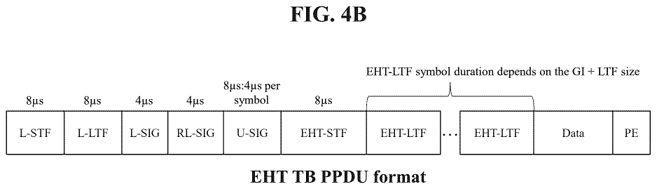

In EHT amendment, two EHT PPDU formats are defined: the EHT MU PPDU and the EHT TB PPDU. Hereinafter, the EHT MU PPDU and the EHT TB PPDU will be described with reference to FIG. 4A and FIG. 4B.

FIG. 4A shows the EHT MU PPDU format in accordance with an embodiment.

The EHT MU PPDU may be used for transmission to one or more users. The EHT MU PPDU is not a response to a triggering frame.

Referring to FIG. 4A, the EHT MU PPDU may include an EHT preamble (hereinafter referred to as a PHY preamble or a preamble), a data field, and a packet extension (PE) field. The EHT preamble may include pre-EHT modulated fields and EHT modulated fields. The pre-EHT modulated fields may include a Non-HT short training field (L-STF), a Non-HT long training field (L-LTF), a Non-HT signal (L-SIG) field, a repeated Non-HT signal (RL-SIG) field, a universal signal (U-SIG) field, and an EHT signal (EHT-SIG) field. The EHT modulated fields may include an EHT short training field (EHT-STF) and an EHT long training field (EHT-LTF). In an embodiment, the L-STF may be immediately followed by the L-LTF immediately followed by the L-SIG field immediately followed by the RL-SIG field immediately followed by the U-SIG field immediately followed by the EHT-SIG field immediately followed by the EHT-STF immediately followed by the EHT-LTF immediately followed by the data field immediately followed by the PE field.

The L-STF field may be utilized for packet detection, automatic gain control (AGC), and coarse frequency-offset correction.

The L-LTF field may be utilized for channel estimation, fine frequency-offset correction, and symbol timing.

The L-SIG field may be used to communicate rate and length information.

The RL-SIG field may be a repeat of the L-SIG field and may be used to differentiate an EHT PPDU from a non-HT PPDU, HT PPDU, and VHT PPDU.

The U-SIG field may carry information necessary to interpret EHT PPDUs.

The EHT-SIG field may provide additional signaling to the U-SIG field for STAs to interpret an EHT MU PPDU. Hereinafter, the U-SIG field, the EHT-SIG field, or both may be referred to as the SIG field.

The EHT-SIG field may include one or more EHT-SIG content channel. Each of the one or more EHT-SIG content channel may include a common field and a user specific field. The common field may include information regarding the resource unit allocation such as the RU assignment to be used in the EHT modulated fields of the PPDU, the RUs allocated for MU-MIMO and the number of users in MU-MIMO allocations. The user specific field may include one or more user fields.

The user field for a non-MU-MIMO allocation may include a STA-ID subfield, a MCS subfield, a NSS (number of spatial streams) subfield, a beamformed subfield, and a coding subfield. The user field for a MU-MIMO allocation may include a STA-ID subfield, a MCS subfield, a coding subfield, and a spatial configuration subfield.

The EHT-STF field may be used to improve automatic gain control estimation in a MIMO transmission.

The EHT-LTF field may enable the receiver to estimate the MIMO channel between the set of constellation mapper outputs and the receive chains.

The data field may carry one or more physical layer convergence procedure (PLCP) service data units (PSDUs).

The PE field may provide additional receive processing time at the end of the EHT MU PPDU.

FIG. 4B shows the EHT TB PPDU format in accordance with an embodiment.

The EHT TB PPDU may be used for a transmission of a response to a triggering frame.

Referring to FIG. 4B, the EHT TB PPDU may include an EHT preamble (hereinafter referred to as a PHY preamble or a preamble), a data field, and a packet extension (PE) field. The EHT preamble may include pre-EHT modulated fields and EHT modulated fields. The pre-EHT modulated fields may include a Non-HT short training field (L-STF), a Non-HT long training field (L-LTF), a Non-HT signal (L-SIG) field, a repeated Non-HT signal (RL-SIG) field, and a universal signal (U-SIG) field. The EHT modulated fields may include an EHT short training field (EHT-STF) and an EHT long training field (EHT-LTF). In an embodiment, the L-STF may be immediately followed by the L-LTF immediately followed by the L-SIG field immediately followed by the RL-SIG field immediately followed by the U-SIG field immediately followed by the EHT-STF immediately followed by the EHT-LTF immediately followed by the data field immediately followed by the PE field. In the EHT TB PPDU, the EHT-SIG field is not present because the trigger frame conveys necessary information and the duration of the EHT_STF field in the EHT TB PPDU is twice the duration of the EHT-STF field in the EHT MU PPDU.

Description for each field in the EHT TB PPDU will be omitted because description for each field in the EHT MU PPDU is applicable to the EHT TB PPDU.

For EHT MU PPDU and EHT TB PPDU, when the EHT modulated fields occupy more than one 20 MHz channels, the pre-EHT modulated fields may be duplicated over multiple 20 MHz channels.

The fields of the EHT PPDU formats described above are summarized below in Table 1.

TABLE 1

| Field | Description |
|---|---|
| L-STF | Non-HT Short Training field |
| L-LTF | Non-HT Long Training field |
| L-SIG | Non-HT SIGNAL field |
| RL-SIG | Repeated Non-HT SIGNAL field |
| U-SIG | Universal SIGNAL field |
| EHT-SIG | EHT SIGNAL field |
| EHT-STF | EHT Short Training field |
| EHT-LTF | EHT Long Training field |
| Data | The Data field carrying the PSDU(s) |
| PE | Packet extension field |

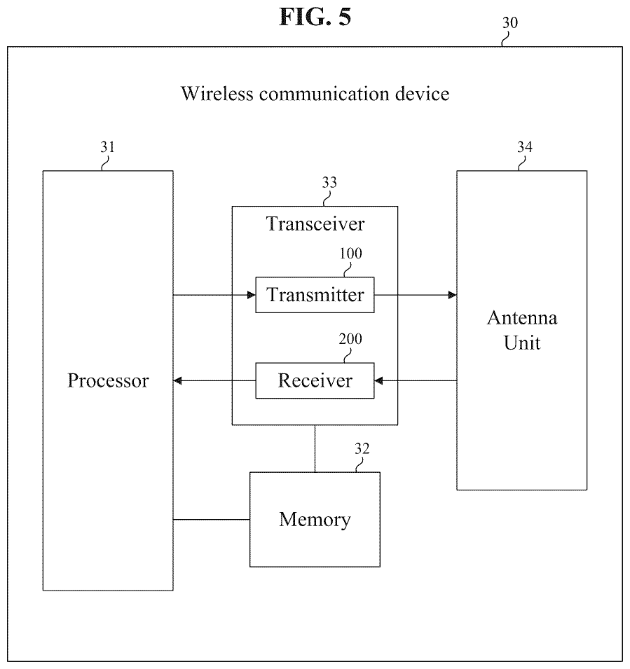

Hereinafter, electronic devices for facilitating wireless communication in accordance with various embodiments will be described with reference to FIG. 5.

FIG. 5 shows a block diagram of an electronic device for facilitating wireless communication in accordance with an embodiment.

Referring to FIG. 5, an electronic device 30 for facilitating wireless communication in accordance with an embodiment may include a processor 31, a memory 32, a transceiver 33, and an antenna unit 34. The transceiver 33 may include a transmitter 100 and a receiver 200.

The processor 31 may perform medium access control (MAC) functions, PHY functions, RF functions, or a combination of some or all of the foregoing. In an embodiment, the processor 31 may comprise some or all of a transmitter 100 and a receiver 200. The processor 31 may be directly or indirectly coupled to the memory 32. In an embodiment, the processor 31 may include one or more processors.

The memory 32 may be non-transitory computer-readable recording medium storing instructions that, when executed by the processor 31, cause the electronic device 30 to perform operations, methods or procedures set forth in the present disclosure. In an embodiment, the memory 32 may store instructions that are needed by one or more of the processor 31, the transceiver 33, and other components of the electronic device 30. The memory may further store an operating system and applications. The memory 32 may comprise, be implemented as, or be included in a read-and-write memory, a read-only memory, a volatile memory, a non-volatile memory, or a combination of some or all of the foregoing.

The antenna unit 34 includes one or more physical antennas. When multiple-input multiple-output (MIMO) or multi-user MIMO (MU-MIMO) is used, the antenna unit 34 may include more than one physical antennas.

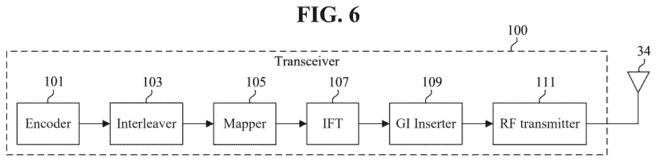

FIG. 6 shows a block diagram of a transmitter in accordance with an embodiment.

Referring to FIG. 6, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder.

The interleaver 103 may interleave bits of encoded data from the encoder 101 to change the order of bits, and output interleaved data. In an embodiment, interleaving may be applied when BCC encoding is employed.

The mapper 105 may map interleaved data into constellation points to generate a block of constellation points. If the LDPC encoding is used in the encoder 101, the mapper 105 may further perform LDPC tone mapping instead of the constellation mapping.

The IFT 107 may convert the block of constellation points into a time domain block corresponding to a symbol by using an inverse discrete Fourier transform (IDFT) or an inverse fast Fourier transform (IFFT).

The GI inserter 109 may prepend a GI to the symbol.

The RF transmitter 111 may convert the symbols into an RF signal and transmits the RF signal via the antenna unit 34.

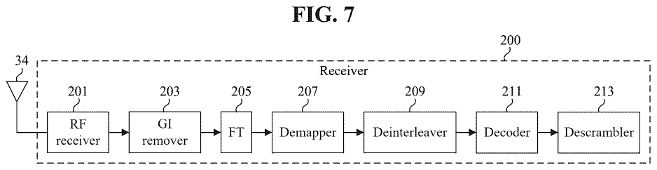

FIG. 7 shows a block diagram of a receiver in accordance with an embodiment.

Referring to FIG. 7, the receiver 200 in accordance with an embodiment may include a RF receiver 201, a GI remover 203, a Fourier transformer (FT) 205, a demapper 207, a deinterleaver 209, a decoder 211, and a descrambler 213.

The RF receiver 201 may receive an RF signal via the antenna unit 34 and converts the RF signal into one or more symbols.

The GI remover 203 may remove the GI from the symbol.

The FT 205 may convert the symbol corresponding a time domain block into a block of constellation points by using a discrete Fourier transform (DFT) or a fast Fourier transform (FFT) depending on implementation.

The demapper 207 may demap the block of constellation points to demapped data bits. If the LDPC encoding is used, the demapper 207 may further perform LDPC tone demapping before the constellation demapping.

The deinterleaver 209 may deinterleave demapped data bits to generate deinterleaved data bits. In an embodiment, deinterleaving may be applied when BCC encoding is used.

The decoder 211 may decode the deinterleaved data bits to generate decoded bits. For example, the decoder 211 may be an FEC decoder. The FEC decoder may include a BCC decoder or an LDPC decoder. In order to support the hybrid automatic repeat request (HARQ) procedure, the decoder 211 may combine a retransmitted data with an initial data.

The descrambler 213 may descramble the decoded data bits based on a scrambler seed.

Hereinafter, a multi-link operation (MLO) in accordance with an embodiment will be described.

The IEEE 802.11be Extremely High Throughput (EHT) task group is currently developing the next generation Wi-Fi standard to achieve higher data rate, lower latency, and more reliable connection to enhance user experience. One of the key features of the IEEE 802.11be standard is a multi-link operation (MLO). As most of the AP STAs and the non-AP STAs incorporate dual-band or tri-band capabilities, the newly developed MLO feature may enable packet-level link aggregation in the MAC layer across different PHY links. By performing load balancing according to traffic requirements, the MLO may achieve significantly higher throughput and lower latency for enhanced reliability in a heavily loaded network. With the MLO capability, a multi-link device (MLD) includes multiple affiliated devices to the upper logical link control (LLC) layer, allowing concurrent data transmission and reception in multiple channels across a single or multiple frequency bands in 2.4 GHz, 5 GHz and 6 GHz.

There exists Wi-Fi technologies that allow a Wi-Fi device to connect to a single link and enable the Wi-Fi device to switch among 2.4 GHZ, 5 GHz and 6 GHz bands. However, such Wi-Fi devices typically have a switching overhead or delay of up to 100 ms. Therefore, the MLO is highly desirable for real-time applications like video calls, wireless VR headsets, cloud gaming and other latency-sensitive applications. The IEEE 802.11be draft specification defines different channel access methods according to two transmission modes: asynchronous and synchronous modes. Under asynchronous transmission mode, the MLD transmits frames asynchronously across multiple links without aligning the starting time. In contrast, in synchronous transmission mode, the starting times are aligned across the links. In either mode, the links may have their own primary channel and parameters, including Packet Protocol Data Unit (PPDU), Modulation and Coding Scheme (MCS), Enhanced Distributed Channel Access (EDCA), etc.

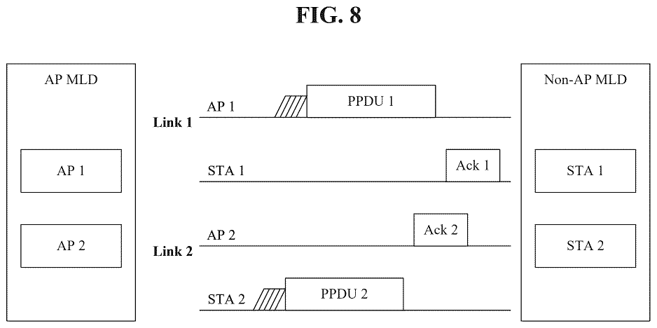

FIG. 8 shows an example multiple link operation in accordance with an embodiment. The example depicted in FIG. 8 is for explanatory and illustration purposes. FIG. 8 does not limit the scope of this disclosure to any particular implementation.

Referring to FIG. 8, an AP MLD has an AP 1 and an AP 2. A Non-AP MLD has an STA 1 and an STA 2. The AP MLD and the Non-AP MLD share a Link 1 and a Link 2. Link 1 is established between AP 1 and STA 1. Link 2 is established between AP 2 and STA 2. The AP MLD transmits, to the Non-AP MLD, a PPDU 1 on Link 1. In response, the Non-AP MLD transmits, to the AP MLD, an Ack 1 on Link 1 acknowledging transmission of PPDU 1. The Non-AP MLD transmits, to the AP MLD, a PPDU 2 on Link 2. In response, the AP MLD transmits, to the non-AP MLD, an Ack 2 on Link 2 acknowledging transmission of PPDU 2. The AP MLD and the Non-AP MLD may transmit and receive the PPDU 1 and the PPDU 2 simultaneously on different links.

In existing Wi-Fi systems, a wireless device, such as an STA or an AP, may support multiple wireless technologies simultaneously, such as Wi-Fi, Bluetooth, or ultrawide band (UWB). An STA supporting multiple wireless technologies simultaneously may experience in-device coexistence (IDC) interference when the STA attempts to send or receive data over Wi-Fi. IDC interference is interference from Bluetooth or UWB communication occurring within the STA and may prevent or delay Wi-Fi data transmission or reception. Such IDC interference is caused by another protocol, in this case Bluetooth or UWB, which uses the same channel as the Wi-Fi (such as unlicensed spectrum bands). Particularly, during IDC interference, communication performance may significantly deteriorate, resulting in issues like data delays and reduced reliability.

An AP that supports dynamic unavailability operation (DUO) may handle IDC interference by identifying an IDC occurrence period where an STA is unavailable (an unavailability period) if the STA supports DUO. DUO provides an operation for a non-AP STA to indicate unavailability in certain Control frames, where the unavailability might overlap with the ongoing TXOP. For example, the AP may instruct the STA to use its maximum reception capability before the IDC interference occurs. The STA, using its maximum reception capability, allows the AP to transmit as much data as possible before the unavailability period. The AP may also use frequency channel switching or link switching to avoid IDC interference. These switching techniques have the benefit of minimizing transmission delays whereas the maximizing reception capability may still result in waiting for the end of the unavailability period to complete the transmission of data.

The AP minimizes the impact of IDC interference on the STA and maintains optimal performance to reduce data transmission delays and improve network stability by acquiring prior notification of the IDC interference from the STA and selects an optimal communication method and channel based on the IDC interference information to enable efficient data transmission.

An AP can request information about an occurrence of IDC interference (an IDC event) from an STA experiencing IDC interference (“IDC STA”) using an Initial Control Frame (ICF) allowed for DUO mode. In an embodiment, the ICF may be a buffer status report poll (BSRP) Trigger frame. An IDC STA may refer to a wireless device that supports multiple wireless technologies simultaneously, such as Wi-Fi and Bluetooth or Wi-Fi and UWB within the same device. The IDC STA can respond to the request for information, for example, by transmitting an Initial Control Response Frame (ICR) allowed for DUO mode, the ICR including information about the IDC event (IDC event information). The IDC event information may include the start time, the duration, frequency band, and affected links of the IDC event. The AP can determine or adjust its communication plan to complete data transmission before the IDC event initiates using the IDC event information. In an embodiment, the AP may use the IDC event information to complete as much of the transmission as possible before the IDC event occurs by requesting the IDC STA to maximize its reception capability. In an embodiment, the AP may use the IDC event information to switch to an alternative channel frequency or link during the IDC event, thereby completing the transmission while avoiding the IDC interference without waiting for the IDC event to end.

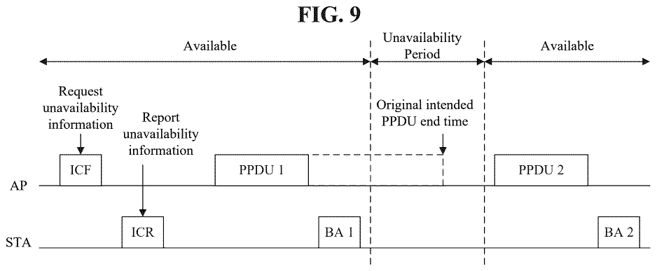

FIG. 9 shows an example PPDU transmission in accordance with an embodiment. The PPDU transmission depicted in FIG. 9 is for explanatory and illustration purposes. FIG. 9 does not limit the scope of this disclosure to any particular implementation.

Referring to FIG. 9, an AP has data (originally intended data) to transmit to an STA. The STA is an IDC STA that anticipates an IDC event, which will result in an unavailability period. The unavailability period is a period of time during which an IDC event occurs. The IDC event occurs one or more times and is capable of being a periodic event. Prior to the unavailability period, the AP transmits, to the STA, an ICF requesting unavailability information regarding the STA, for example and without limitation, including the unavailability period. In response, the STA transmits, to the AP, an ICR reporting the unavailability information regarding the STA including the unavailability period. Subsequently, the AP transmits, to the STA, a PPDU 1 including a first portion of the originally intended data the AP has to transmit to the STA. The first portion of the originally intended data includes a portion of the originally intended data that is small enough for transmission to be completed prior to the unavailability period. The originally intended data is too large for transmission of a PPDU including the originally intended data to be completed prior to the unavailability period. In response, the STA transmits, to the AP, a block acknowledgement (BA) 1 acknowledging the PPDU 1. Subsequently the unavailability period begins and ends without interfering with the data transmission between the AP and the STA. After the unavailability period ends, the STA is available for transmission of a second portion of the originally intended data including a remaining portion of the originally intended data. The AP transmits, to the STA, a PPDU 2 including the second portion of the originally intended data. In response, the STA transmits, to the AP, a BA 2 acknowledging the PPDU 2.

In FIG. 9, the AP avoids IDC interference by completing transmission of the first portion of data prior to the unavailability period and completing transmission of the second portion of data after the unavailability period. By avoiding transmission during the unavailability period, the AP minimizes data loss caused by IDC interference and improves network stability. However, this method of avoiding transmission during the unavailability period may result in a reduction in data transmitted compared to the original intended data. Therefore, alternative methods can be employed to avoid this reduction in data transmitted.

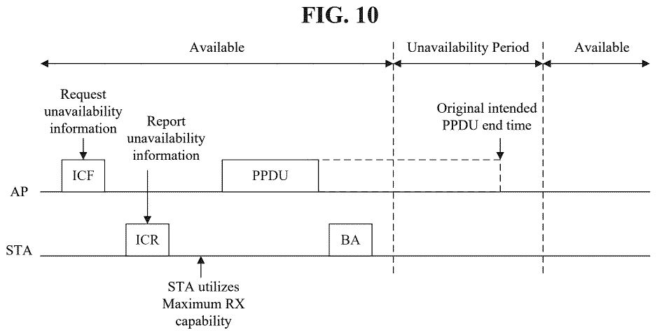

FIG. 10 shows another example PPDU transmission in accordance with an embodiment. The PPDU transmission depicted in FIG. 10 is for explanatory and illustration purposes. FIG. 10 does not limit the scope of this disclosure to any particular implementation.

Referring to FIG. 10, an AP has data to transmit to an STA. The STA is an IDC STA that anticipates an IDC event, which will result in an unavailability period. The unavailability period is a period of time during which an IDC event occurs. The IDC event occurs one or more times and is capable of being a periodic event. Prior to the unavailability period, the AP transmits, to the STA, an ICF requesting unavailability information regarding the STA, for example and without limitation, including the unavailability period and requesting that the STA operate in its maximum receive (RX) capability mode. In response, the STA transmits, to the AP, an ICR reporting the unavailability information regarding the STA and the unavailability period. The ICR also acknowledges the request that the STA operate in its maximum RX capability mode. The STA begins or continues operating in its maximum RX capability mode. The AP transmits a PPDU including the data the AP intends to transmit to the STA based on the STA's maximized RX capability, using a MCS with a higher tone MRU than the MCS the STA was using before the STA was operating on its maximum RX capability or a greater NSS than the NSS the STA was using before the STA was operating on its maximum RX capability. Accordingly, transmission of the PPDU can be completed prior to the unavailability period. In response, the STA transmits, to the AP, a BA acknowledging the PPDU.

In another embodiment, in FIG. 10, the PPDU includes a first portion of the data the AP intends to transmit to the STA (originally intended data). The first portion of the originally intended data includes a portion of the originally intended data that is small enough for transmission based on the STA's maximized RX capability to be completed prior to the unavailability period. The originally intended data is too large for transmission based on the STA's maximized RX capability of a PPDU including the originally intended data to be completed prior to the unavailability period. Subsequently the unavailability period begins and ends without interfering with the data transmission between the AP and the STA. After the unavailability period ends, the STA is available for transmission of a second portion of the originally intended data including a remaining portion of the originally intended data.

In an embodiment, an AP can request information on available channels of an STA, those channels being within the STA's operating bandwidth that, despite potential IDC interference, can still support data transmission and reception. The STA can respond with a report including channels where interference signal strength remains below a specified threshold during the IDC event. In response, the AP may indicate to the STA the need to switch channels, for example, using a channel switching instruction field within a PPDU transmitted during a TXOP to the STA. The STA can indicate a confirmation of the channel switching. Then, the AP and the STA may perform the channel switch negotiation and then switch to another channel. The original channel, which the AP and the STA were active on before switching channels, is a primary channel. The primary channel is the common channel of operation for all STAs that are members of the BSS. The channel, which the AP and the STA switched to, is a secondary channel. The secondary channel is a channel associated with a primary channel used to create a channel wider than the primary channel. The AP and the STA may continue transmitting and receiving data through the secondary channel, avoiding the IDC interference. Therefore, the AP and the STA may reduce transmission delays by switching to channels that avoid IDC interference during unavailability periods to perform data transmissions.

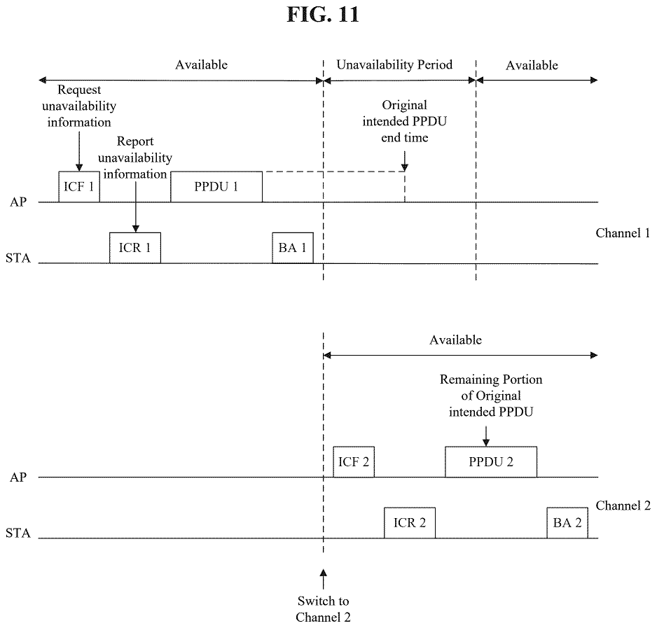

FIG. 11 shows example PPDU transmissions in accordance with an embodiment. The PPDU transmissions depicted in FIG. 11 is for explanatory and illustration purposes. FIG. 11 docs not limit the scope of this disclosure to any particular implementation.

Referring to FIG. 11, an AP has data (originally intended data) to transmit to an STA. The AP and the STA are communicating on Channel 1. The STA is an IDC STA that anticipates an IDC event, which will result in an unavailability period. The unavailability period is a period of time during which an IDC event occurs. The IDC event occurs one or more times and is capable of being a periodic event. Prior to the unavailability period, the AP transmits, to the STA, an ICF 1 requesting unavailability information regarding the STA, for example and without limitation, including the unavailability period and available channels. In an embodiment, the available channels may include secondary channels which support data transmission and reception despite the unavailability period. In response, the STA transmits, to the AP, an ICR 1 reporting the requested unavailability information regarding the STA, including the unavailability period and available channels. Subsequently, the AP transmits, to the STA, a PPDU 1, including a first portion of the originally intended data, the AP has to transmit to the STA. The PPDU 1 also includes an indication for the STA to switch channels in a field (for example, a channel switching instruction of field) of the PPDU 1. The first portion of the originally intended data includes a portion of the originally intended data that is small enough for transmission to be completed prior to the unavailability period. The originally intended data is too large for transmission of a PPDU including the originally intended data to be completed prior to the unavailability period. In response, the STA transmits, to the AP, a BA 1 acknowledging the PPDU 1. The BA 1 also indicates confirmation of switching channels. Subsequently, the AP and the STA switch to Channel 2. In an embodiment, Channel 1 may be a primary channel and Channel 2 may be a secondary channel. The AP transmits, to the STA, an ICF 2 requesting unavailability information regarding the STA including a potential IDC event on Channel 2. In response, the STA transmits, to the AP, an ICR 2 reporting the requested unavailability information regarding the STA and the potential IDC event on Channel 2. The ICR indicates that the STA is available on Channel 2 for transmitting and receiving data. Subsequently, the AP transmits, to the STA, a PPDU 2 including a second portion of the originally intended data the AP has to transmit to the STA, wherein the second portion of the data includes a remaining portion of the originally intended data. In response, the STA transmits, to the AP, a BA 2 acknowledging the PPDU 2.

In an embodiment, a BA may include a confirmation of switching channels in a channel switching instruction field of the BA.

An AP MLD and an STA MLD are associated with multiple links. In an embodiment, the AP MLD and the STA MLD are transmitting and receiving data through a Link 1. The AP MLD can inform the STA MLD via an ICF that the AP MLD intends to use a Link 2 for transmitting and receiving data during an unavailability period resulting from an IDC event on Link 1. The STA MLD can acknowledge, for example, that the AP MLD will use Link 2 for transmitting and receiving data during the unavailability period via an ICR. The AP MLD completes the transmission of a first PPDU including a portion of data through Link 1 before the unavailability period. The AP MLD then completes transmission of a second PPDU including a remaining portion of the data through Link 2 during the unavailability period. The AP MLD can switch Link 2 to an active state if the AP MLD's Link 2 is not activated. The STA MLD can switch Link 2 to an active state if the STA MLD's Link 2 is not activated. The AP MLD and the STA MLD can avoid IDC interference during the unavailability period and receive data through Link 2.

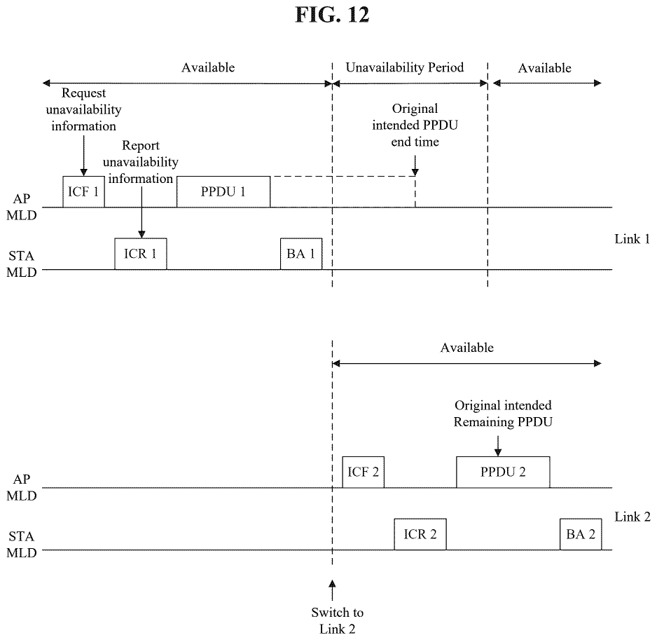

FIG. 12 shows further example PPDU transmissions in accordance with an embodiment. The PPDU transmissions depicted in FIG. 12 is for explanatory and illustration purposes. FIG. 12 does not limit the scope of this disclosure to any particular implementation.

Referring to FIG. 12, an AP MLD has data (originally intended data) to transmit to an STA MLD. The AP MLD and the STA MLD are associated with Link 1. The STA MLD is an IDC STA MLD that anticipates an IDC event, which will result in an unavailability period. The unavailability period is a period of time during which an IDC event occurs. The IDC event occurs one or more times and is capable of being a periodic event. Prior to the unavailability period, the AP MLD transmits, to the STA MLD, an ICF 1 requesting unavailability information regarding the STA MLD, for example and without limitation, including the unavailability period, and indicating that the AP MLD will transmit and receive data through Link 2 during the unavailable period. In response, the STA MLD transmits, to the AP MLD, an ICR 1 reporting the requested unavailability information regarding the STA MLD including the unavailability period. The ICR 1 also includes an acknowledgement of the AP MLD's intention to transmit and receive data through Link 2. Subsequently, the AP MLD transmits, to the STA MLD, a PPDU 1 including a first portion of the originally intended data, the AP MLD has to transmit to the STA MLD. The first portion of the originally intended data includes a portion of the originally intended data that is small enough for transmission to be completed prior to the unavailability period. The originally intended data is too large for transmission of a PPDU including the originally intended data to be completed prior to the unavailability period. In response, the STA MLD transmits, to the AP MLD, a BA 1 acknowledging the PPDU 1. Subsequently, the AP MLD and the STA MLD transmit and receive data through Link 2. The AP MLD transmits, to the STA MLD, an ICF 2 requesting unavailability information regarding the STA MLD and a potential IDC event on Link 2. In response, the STA MLD transmits, to the AP MLD, an ICR 2 reporting the requested unavailability information regarding the STA MLD including the potential IDC event on Link 2. Subsequently, the AP MLD transmits, to the STA MLD, a PPDU 2 including the second portion of the originally intended data the AP MLD has to transmit to the STA MLD, wherein the second portion of the data includes a remaining portion of the originally intended data. In response, the STA MLD transmits, to the AP MLD, a BA 2.

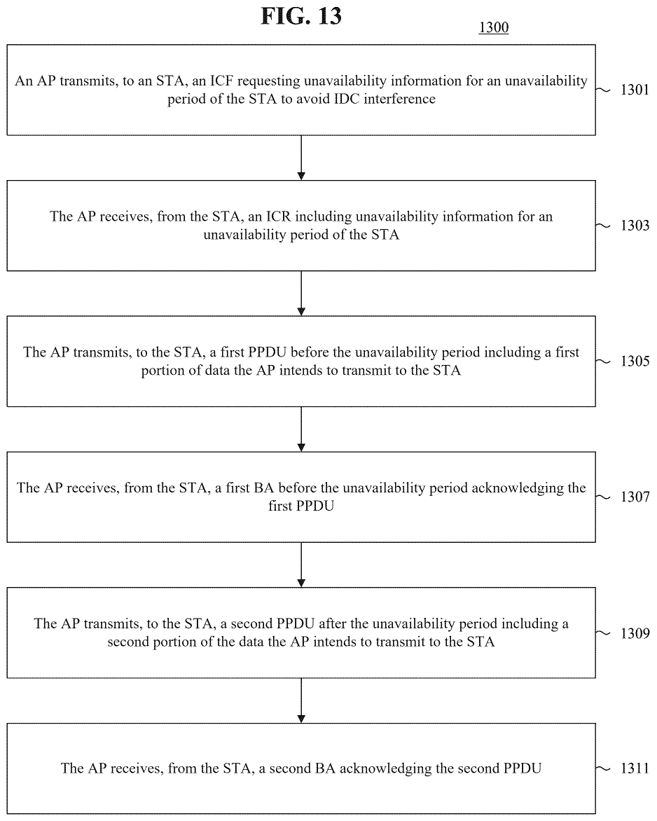

FIG. 13 shows an example process in accordance with an embodiment. The process depicted in FIG. 13 is for explanatory and illustration purposes. FIG. 13 does not limit the scope of this disclosure to any particular implementation.

Referring to FIG. 13, the process 1300 begins at operation 1301. In operation 1301, an AP transmits, to an STA, an ICF requesting unavailability information for an unavailability period of the STA to avoid IDC interference. The ICF may indicate a request that the STA use its maximum RX capacity for receiving data prior to the unavailability period. The ICF may include a request for available channels. The AP may be an AP MLD and the STA may be an STA MLD. The AP MLD and the STA MLD share and associated link for transmitting and receiving prior to the unavailability period. If the AP is an AP MLD and the STA is an STA MLD then the ICF may indicate that the AP MLD intends to transmit and receive through a second link during and after the unavailability period.

In operation 1303, the AP receives, from the STA, an ICR including unavailability information for an unavailability period of the STA. If the ICF indicated that the STA use its maximum RX capacity for receiving data prior to the unavailability period then the ICR may include an acknowledgement and agreement to use the STA's maximum RX capacity for receiving data prior to the unavailability period. The ICR may include information on available channels. If the AP is an AP MLD and the STA is an STA MLD then the ICR may indicate an acknowledgement that the AP MLD intends to transmit and receive through the second link.

In operation 1305, the AP transmits, to the STA, a first PPDU before the unavailability period including a first portion of data that the AP intends to transmit to the STA. If the STA is using its maximum RX capacity for receiving data prior to the unavailability period then the first PPDU includes the first portion of data as well as another portion of data where the first portion of data and the other portion of data are less than or equal to the data the AP intends to transmit to the STA. If the first portion of the data and the other portion of the data are equal to the data the AP intends to transmit to the STA, then the process completes at operation 1307.

In operation 1307, the AP receives, from the STA, a first BA before the unavailability period acknowledging the first PPDU.

In operation 1309, the AP transmits, to the STA, a second PPDU after the unavailability period including a second portion of the data the AP intends to transmit to the STA. The AP and the STA may switch to an available channel determined in the negotiation of the ICF and ICR for transmitting and receiving the second PPDU during and after the unavailability period. If the AP is an AP MLD and the STA is an STA MLD then the AP MLD may transmit the second PPDU through the second link.

In operation 1311, the AP receives, from the STA, a second BA acknowledging the second PPDU. If the AP and the STA have switched to the available channel for transmitting and receiving the second PPDU then the transmitting and receiving of the second BA will be completed on the available channel. If the AP is an AP MLD and the STA is an STA MLD then the AP may receive the second BA through the second link.

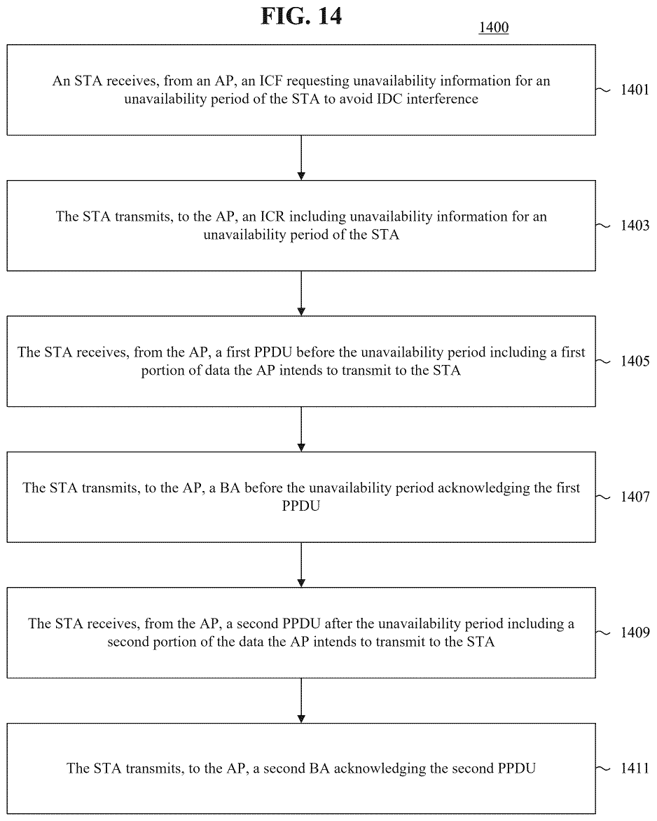

FIG. 14 shows another example process in accordance with an embodiment. The process depicted in FIG. 14 is for explanatory and illustration purposes. FIG. 14 does not limit the scope of this disclosure to any particular implementation.

Referring to FIG. 14, the process 1400 begins at operation 1401. In operation 1401, an STA receives, from an AP, an ICF requesting unavailability information for an unavailability period of the STA to avoid IDC interference. The ICF may indicate a request that the STA use its maximum RX capacity for receiving data prior to the unavailability period. The ICF may include a request for available channels. The AP may be an AP MLD and the STA may be an STA MLD. The AP MLD and the STA MLD share and associated link for transmitting and receiving prior to the unavailability period. If the AP is an AP MLD and the STA is an STA MLD then the ICF may indicate that the AP MLD intends to transmit and receive through a second link during and after the unavailability period.

In operation 1403, the STA transmits, to the AP, an ICR including unavailability information for an unavailability period of the STA. If the ICF indicated that the STA use its maximum RX capacity for receiving data prior to the unavailability period then the ICR may include an acknowledgement and agreement to use the STA's maximum RX capacity for receiving data prior to the unavailability period. The ICR may include information on available channels. If the AP is an AP MLD and the STA is an STA MLD then the ICR may indicate an acknowledgement that the AP MLD intends to transmit and receive through the second link.

In operation 1405, the STA receives, from the AP, a first PPDU before the unavailability period including a first portion of data the AP intends to transmit to the STA. If the STA is using its maximum RX capacity for receiving data prior to the unavailability period then the first PPDU includes the first portion of data as well as another portion of data where the first portion of data and the other portion of data are less than or equal to the data the AP intends to transmit to the STA. If the first portion of the data and the other portion of the data are equal to the data the AP intends to transmit to the STA, then the process completes at operation 1407.

In operation 1407, the STA transmits, to the AP, a first BA before the unavailability period acknowledging the first PPDU.

In operation 1409, the STA receives, from the AP, a second PPDU after the unavailability period including a second portion of the data the AP intends to transmit to the STA. The AP and the STA may switch to an available channel determined in the negotiation of the ICF and ICR for transmitting and receiving the second PPDU during and after the unavailability period. If the AP is an AP MLD and the STA is an STA MLD then the AP MLD may transmit the second PPDU through the second link.

In operation 1411, the STA transmits, to the AP, a second BA acknowledging the second PPDU. If the AP and the STA have switched to the available channel for transmitting and receiving the second PPDU then the transmitting and receiving of the second BA will be completed on the available channel. If the AP is an AP MLD and the STA is an STA MLD then the AP may receive the second BA through the second link.

The disclosure provides mechanisms and procedures for DUO to avoid IDC interference reducing transmission delays which resolves latency issues and improves network stability in wireless communication involving devices that support multiple wireless technologies.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) device for facilitating communication in a wireless network, comprising:
a memory; and
a processor coupled to the memory, the processor configured to cause:
transmitting, to a station (STA) device, a request frame requesting information associated with an unavailability period, wherein the STA device is not available for transmitting or receiving frames during the unavailability period;
receiving, from the STA device, a response frame including information associated with the unavailability period; and
transmitting, to the STA device, a first data frame based on the information associated with the unavailability period, wherein transmission of the first data frame is completed before a start of the unavailability period.

2. The AP device of claim 1, wherein the processor is further configured to cause:
transmitting, to the STA device, a second data frame after the unavailability period, wherein the first data frame includes a portion of data that the AP device intends to transmit, and the second data frame includes a remaining portion of the data.

3. The AP device of claim 1, wherein:
the request frame includes a request that the STA device increases the STA device's reception capability;
the response frame includes an indication of the STA device's increased reception capability; and
the first data frame is transmitted based on the STA device's increased reception capability.

4. The AP device of claim 3, wherein the first data frame is transmitted based on a modulation and coding scheme associated with the STA device's increased reception capability or a number of spatial streams associated with the STA device's increased reception capability.

5. The AP device of claim 1, wherein:
the request frame includes a request for information on an alternative channel which is available during the unavailability period;
the response frame includes information on an alternative channel which is available during the unavailability period; and
the processor is further configured to cause:
transmitting, to the STA device, a second data frame on the alternative channel during the unavailability period, wherein the first data frame includes a portion of data that the AP device intends to transmit, and the second data frame includes a remaining portion of the data.

6. The AP device of claim 5, wherein the first data frame is transmitted on a primary channel, and the alternative channel is a secondary channel.

7. The AP device of claim 5, wherein the response frame includes information on a plurality of alternative channels which are available during the unavailability period, and
the processor is further configured to cause:
selecting the alternative channel from the plurality of alternative channels.

8. The AP device of claim 5, wherein the alternative channel is determined to be available if signal strength of interference on the alternative channel is below a predetermined threshold during the unavailability period.

9. The AP device of claim 1, wherein:
the AP device is an AP multi-link device (MLD) comprising a plurality of APs;
the STA device is an STA MLD comprising a plurality of STAs;
the first data frame is transmitted on a first link established between the AP device and the STA device; and
the processor is further configured to cause:
transmitting, to the STA device, a second data frame on a second link established between the AP device and the STA device during the unavailability period, wherein the second link is available during the unavailability period, and the first data frame includes a portion of data that the AP device intends to transmit, and the second data frame includes a remaining portion of the data.

10. The AP device of claim 1, wherein the information associated with the unavailability period comprises a start time, a duration, a frequency band, an identifier of links affected by the unavailability period, or an indication that the unavailability period is associated with device coexistence interference.

11. A station (STA) device for facilitating communication in a wireless network, comprising:
a memory; and
a processor coupled to the memory, the processor configured to cause:
receiving, from an access point (AP) device, a request frame requesting information associated with an unavailability period, wherein the STA device is not available for transmitting or receiving frames during the unavailability period;
transmitting, to the AP device, a response frame including information associated with the unavailability period; and
receiving, from the AP device, a first data frame, wherein transmission of the first data frame is completed before a start of the unavailability period.

12. The STA device of claim 11, wherein the processor is further configured to cause:
receiving, from the AP device, a second data frame after the unavailability period, wherein the first data frame includes a portion of data that the AP device intends to transmit, and the second data frame includes a remaining portion of the data.

13. The STA device of claim 11, wherein:
the request frame includes a request that the STA device increases the STA device's reception capability;
the response frame includes an indication of the STA device's increased reception capability; and
the first data frame is transmitted based on the STA device's increased reception capability.

14. The STA device of claim 13, wherein the first data frame is transmitted based on a modulation and coding scheme associated with the STA device's increased reception capability or a number of spatial streams associated with the STA device's increased reception capability.

15. The STA device of claim 11, wherein:
the request frame includes a request for information on an alternative channel which is available during the unavailability period;
the response frame includes information on an alternative channel which is available during the unavailability period; and
the processor is further configured to cause:
receiving, from the AP device, a second data frame on the alternative channel during the unavailability period, wherein the first data frame includes a portion of data that the AP device intends to transmit and the second data frame includes a remaining portion of the data.

16. The STA device of claim 15, wherein the first data frame is transmitted on a primary channel, and the alternative channel is a secondary channel.

17. The STA device of claim 15, wherein the alternative channel is determined to be available if signal strength of interference on the alternative channel is below a predetermined threshold during the unavailability period.

18. The STA device of claim 11, wherein:
the STA device is an STA multi-link device (MLD) comprising a plurality of STAs;
the AP device is an AP MLD comprising a plurality of APs;
the first data frame is transmitted on a first link established between the AP device and the STA device; and
the processor is further configured to cause:
receiving, from the AP device, a second data frame on a second link established between the AP device and the STA device during the unavailability period, wherein the second link is available during the unavailability period, and the first data frame includes a portion of data that the AP device intends to transmit, and the second data frame includes a remaining portion of the data.

19. The STA device of claim 11, wherein the information associated with the unavailability period comprises a start time, a duration, a frequency band, an identifier of links affected by the unavailability period, or an indication that the unavailability period is a result of device coexistence interference.

20. A method performed by an access point (AP) device for facilitating communication in a wireless network, the method comprising:
transmitting, to a station (STA) device, a request frame requesting information associated with an unavailability period, wherein the STA device is not available for transmitting or receiving frames during the unavailability period;
receiving, from the STA device, a response frame including information associated with the unavailability period; and
transmitting, to the STA device, a first data frame based on the information associated with the unavailability period, wherein transmission of the first data frame is completed before a start of the unavailability period.
